(19) United States
(12) Patent Application Publication
(10) Pub. No.: US 2003/0108655 A1
(43) Pub. Date: Jun. 12, 2003

(54) Method for preventing freezing denaturation of fish meat or flaked fish meat

(76) Inventor: Mitsuo Ishifune, Chiba-ken (JP)

Correspondence Address: WENDEROTH, LIND & PONACK, L.L.P., 2033 K STREET N. W., SUITE 800, WASHINGTON, DC, 20006-1021, US

(21) Appl. No.: 10/296,332

(22) PCT Filed: May 24, 2001
(86) PCT No.: PCT/JP01/04376

(30) Foreign Application Priority Data
May 24, 2000 (JP) 2000-153151

(51) Int. Cl. A23L 1/325

(52) U.S. Cl. 426/643

(57) ABSTRACT

This invention includes: an additive-liquid preparation step of preparing an additive liquid 10 into which water 11, a pH adjuster 12, a water-soluble food material 13 and salt 15 have been mixed; and an additive-liquid permeation step of causing the additive liquid 10 to permeate into the piece of fish meat 20. According to the feature, it may be effectively prevented that freeze denaturation occur during a subsequent freezing process for the piece of fish meat.

### FIELD OF THE INVENTION

The invention relates to a method of processing a pre-frozen fish meat or a pre-frozen piece of fish meat in order to prevent a freeze denaturation of the fish meat or the piece of fish meat or a method of processing a thawed fish meat or a thawed piece of fish meat before re-freezing the thawed fish meat or the thawed piece of fish meat, in particular to a method according to which a taste of the finally thawed fish meat or the finally thawed piece of fish meat is delicious.

### DESCRIPTION OF THE RELATED ART

Conventionally, a piece of fish meat of an edible fish may be frozen and preserved. The frozen and preserved piece of fish meat may be thawed and processed to a state losing an original shape thereof (for example broken up to flakes and seasoned, heated for a long time and seasoned such as boiled in sweetened soy source, or seasoned and dried). In that case, they may be eaten with bad effect being less in tastes of them by freeze denaturation. Recently, they tend to be cooked more often while the original shape thereof is maintained. Alternatively, they tend to be eaten more often as a raw fish while the original shape thereof is maintained. However, a piece of fish meat that has been frozen and thawed while maintaining the original shape thereof is evaluated to be tough as fish meat, lack juiciness and have a worse taste than fresh fish meat.

The inventor has studied factors lacking the juiciness when the piece of fish meat is frozen and thawed while maintaining the original shape thereof. As a result, it has been found that when the piece of fish meat is frozen it may be denatured (freeze denaturation) such that moisture-holding property thereof may be reduced and fibers thereof may become tough, which may mainly cause lack of the juiciness.

The freeze denaturation may be generated by moisture in cells of the fish meat becoming ice-crystal, expanding, and destroying the cells from their insides, when the cells of the fish meat are frozen. The destroyed cells causes various nutriments therein, which should be staying in the cells, to flow out during the successive thawing step or processing (cooking) step. Therefore, the piece of fish meat that has been frozen and thawed has only less juiciness.

As a method of preventing the freeze denaturation of the fish meat, there is known a method of preventing freeze denaturation of ground fish meat. In the method, a piece of fish meat is crushed and mashed into ground fish meat, exposed to water, then dehydrated, and added saccharide and polymerized phosphate.

However, although the method is effective in the crushed fish meat as the ground fish meat, the method is not sufficiently effective in preventing the freeze denaturation of fish meat maintaining an original shape thereof.

In addition, for a high-quality food such as a tuna, a quick freezing process may be conducted in order to control size of ice-crystal during the freezing process, that is, in order to prevent cells from being destroyed during the freezing process. However, for the case, the frozen state has to be about −60° C. Thus, a special freezing system is necessary, which needs more cost.

### SUMMARY OF THE INVENTION

The present invention has been made in view of the foregoing circumstances. Therefore, the object of this invention is to provide a method capable of effectively preventing freeze denaturation of a fish meat or a piece of fish meat that has had an original shape thereof.

The inventor has found that: in order to achieve the above object, it is effective to prepare an additive liquid that has a higher density with respect to a substance, which is the same as dissolving in a cell sap contained in a fish-meat cell of the piece of fish meat, than in the cell sap; and to cause the additive liquid to permeate into the piece of fish meat in order to discharge water in the fish-meat cell outward due to osmotic pressure, to increase density of the cell sap in the fish-meat cell. In addition, by reducing moisture contained in the fish-meat cell and by further increasing the density of the substance dissolving in the cell sap by means of salinity or a water-soluble food material added therein, it may be prevented that the freeze occur in a range of temperature allowing a maximum size of ice-crystal to be generated. That is, it was made possible that the freeze occur below the range of temperature. Thus, the size of the ice-crystal can be controlled, and possibility of destroying the cell can be remarkably reduced.

In addition, freeze denaturation during a long frozen preservation, which may occur in a case of conventionally adding a pH adjuster and salt or salt alone, can be satisfactorily prevented in a range of about −18 to −25° C., which is a generally frozen preservation temperature, by adding a water-soluble food material.

Furthermore, the inventor has devoted himself to study for components in the additive liquid and has found combinations of the components suitable for a taste of the finally thawed piece of fish meat.

That is, this invention is a method of preventing a freeze denaturation of a fish meat or a piece of fish meat, said method comprising: an additive-liquid preparation step of preparing an additive liquid into which water, a pH adjuster, a water-soluble food material and salt have been mixed; and an additive-liquid permeation step of causing the additive liquid to permeate into the fish meat or the piece of fish meat.

According to the feature, by causing the additive liquid including the water, the pH adjuster, the water-soluble food material and the salt to permeate into the fish meat or the piece of fish meat, it may be effectively prevented that the freeze denaturation occur.

Preferably, the water-soluble food material includes one of chemical condiment, natural-material extract and saccharide.

For example, the fish meat or the piece of fish meat may be a thawed fish meat or a thawed piece of fish meat. In the case, it may be prevented that the freeze denaturation occur during the continuous frozen state or during a subsequent re-freezing process. That is, quality deterioration caused by a long frozen preservation may be remarkably prevented.

In the additive-liquid permeation step for the thawed fish meat or the thawed piece of fish meat, it has been found that the additive liquid is caused to permeate into the thawed fish meat or the thawed piece of fish meat preferably in an amount of 10 to 20 weight % with respect to a weight of the thawed fish meat or the thawed piece of fish meat.

Alternatively, the fish meat or the piece of fish meat may be a fresh fish meat or a fresh piece of fish meat. In the case, it may be prevented that the freeze denaturation occur during a subsequent freezing process. That is, quality deterioration caused by a frozen preservation may be remarkably prevented.

In the additive-liquid permeation step for the fresh fish meat or the fresh piece of fish meat, it has been found that the additive liquid is caused to permeate into the fresh fish meat or the fresh piece of fish meat preferably in an amount of 3 to 10 weight % with respect to a weight of the fresh fish meat or the fresh piece of fish meat.

In addition, regarding the additive liquid, preferably, the pH adjuster in the additive liquid is caused to permeate into the fish meat or the piece of fish meat in an amount of 0.5 weight % or below, the water-soluble food material in the additive liquid is caused to permeate into the fish meat or the piece of fish meat in an amount of 0.3 to 7.0 weight %, and the salt in the additive liquid is caused to permeate into the fish meat or the piece of fish meat in an amount of 0.15 to 2.0 weight %.

Especially, for the thawed fish meat or the thawed piece of fish meat, preferably, the pH adjuster in the additive liquid is caused to permeate into the fish meat or the piece of fish meat in an amount of 0.40 to 0.50 weight %, the water-soluble food material in the additive liquid is caused to permeate into the fish meat or the piece of fish meat in an amount of 2.00 to 2.50 weight %, and the salt in the additive liquid is caused to permeate into the fish meat or the piece of fish meat in an amount of 0.5 to 0.7 weight %. More preferably, the pH adjuster in the additive liquid is caused to permeate into the fish meat or the piece of fish meat in an amount of 0.45 weight %, the water-soluble food material in the additive liquid is caused to permeate into the fish meat or the piece of fish meat in an amount of 2.25 weight %, and the salt in the additive liquid is caused to permeate into the fish meat or the piece of fishmeat in an amount of 0.6 weight %.

Alternatively, for the fresh fish meat or the fresh piece of fish meat, preferably, the pH adjuster in the additive liquid is caused to permeate into the fish meat or the piece of fish meat in an amount of 0.13 to 0.17 weight %, the water-soluble food material in the additive liquid is caused to permeate into the fish meat or the piece of fish meat in an amount of 0.67 to 0.83 weight %, and the salt in the additive liquid is caused to permeate into the fish meat or the piece of fish meat in an amount of 0.18 to 0.22 weight %. More preferably, the pH adjuster in the additive liquid is caused to permeate into the fish meat or the piece of fish meat in an amount of 0.15 weight %, the water-soluble food material in the additive liquid is caused to permeate into the fish meat or the piece of fish meat in an amount of 0.75 weight %, and the salt in the additive liquid is caused to permeate into the fish meat or the piece of fish meat in an amount of 0.2 weight %.

The additive-liquid permeation step includes a step of inputting the piece of fish meat and the additive liquid into a stirring machine, and a step of operating the stirring machine gently. Alternatively, the additive-liquid permeation step includes a step of filling a permeation container with the additive liquid, and a step of soaking the piece of fish meat in the additive liquid in the permeation container for a predetermined time. Alternatively, the additive-liquid permeation step includes a step of injecting the additive liquid into a pre-processed fish body, a fish body whose head and/or viscera are removed, a fillet or a cut piece of fish meat having a non-fixed shape.

In addition, an additive liquid for preventing a freeze denaturation of a fish meat or a piece of fish meat, which is prepared in the above method, should be also protected by the application. In addition, a fish meat or a piece of fish meat into which the additive liquid has been caused to permeate according to the above method to prevent freeze denaturation should be also protected by the application.

### BRIEF DESCRIPTION OF THE DRAWINGS

FIG. 1 is a flowchart of a first embodiment of a method of preventing a freeze denaturation of a piece of fish meat according to the invention;

FIG. 2 is a schematic view of the additive-liquid permeation step shown in FIG. 1;

FIG. 3 is a flowchart of a second embodiment of a method of preventing a freeze denaturation of a piece of fishmeat according to the invention;

FIG. 4 is a schematic view of the additive-liquid permeation step shown in FIG. 3;

FIG. 5 is a flowchart of a third embodiment of a method of preventing a freeze denaturation of a piece of fish meat according to the invention; and

FIG. 6 is a schematic view of the additive-liquid permeation step shown in FIG. 5.

### BEST MODE FOR CARRYING OUT THE INVENTION

Embodiments of the invention are explained in more detail with reference to the drawings.

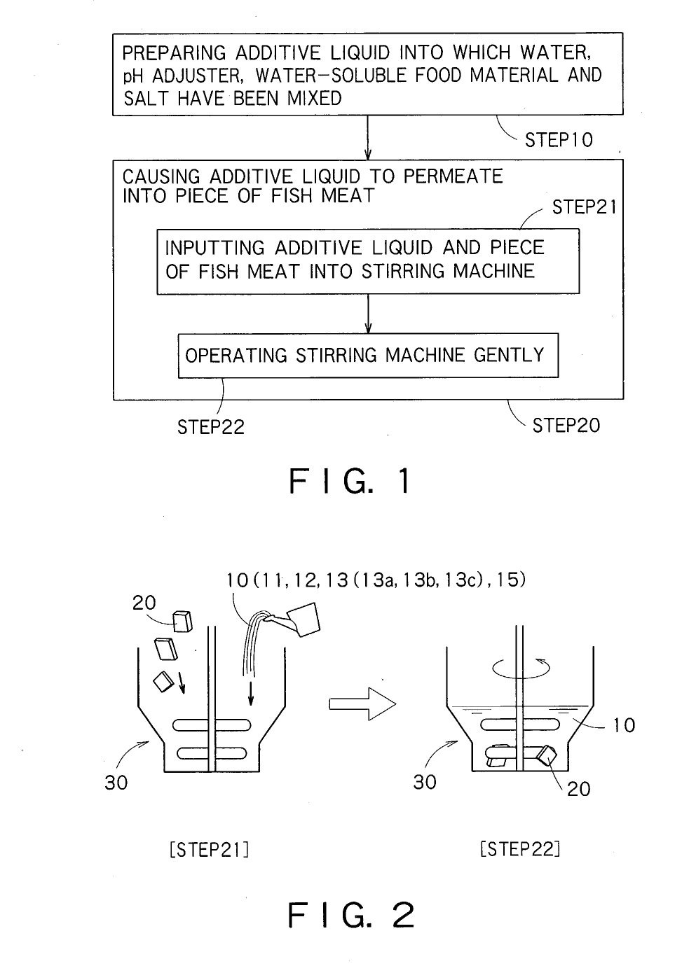

FIG. 1 is a flowchart of a first embodiment of a method of preventing a freeze denaturation of a piece of fish meat according to the invention. As shown in FIG. 1, the embodiment includes: an additive-liquid preparation step (STEP 10) of preparing an additive liquid 10 into which water 11, a pH adjuster 12, a water-soluble food material 13 and salt 15 have been mixed; and an additive-liquid permeation step (STEP 20) of causing the additive liquid 10 to permeate into a piece of fish meat 20. FIG. 2 is a schematic view of the additive-liquid permeation step shown in FIG. 1.

In the case, the piece of fish meat 20 is a piece of salmon that has been frozen for preservation and then thawed.

The pH adjuster 12 is contained to adjust a pH value of the additive liquid 10 in order to promote permeation of the additive liquid 10 into the piece of fish meat 20. In general, polymerized phosphate may be used.

The water-soluble food material 13 consists of a mixture solution of chemical condiment 13a such as amino acids, natural-material extract 13b such as fish-meat extract and saccharide 13c. The water-soluble food material 13 may consist of only any one or two of the above three components.

The water-soluble food material 13 and the salt 15 are contained to adjust the taste and to raise osmotic pressure of the additive liquid.

As shown in FIGS. 1 and 2, the additive-liquid permeation step (STEP 20) of the embodiment includes a step (STEP 21) of inputting the piece of fish meat 20 and the additive liquid 10 into a stirring machine 30, and a step (STEP 22) of operating the stirring machine 30 gently.

The additive liquid 10 of the embodiment consists of the water 11 of 74 to 82 weight %, the pH adjuster 12 of 2 to 4 weight %, the water-soluble food material 13 of 13 to 17 weight %, and the salt 15 of 3 to 5 weight %, especially, the water 11 of 78 weight %, the pH adjuster 12 of 3 weight %, the total of the chemical condiment 13a, the natural-material extract 13b and the saccharide 13c of 15 weight %, and the salt 15 of 4 weight %.

In the embodiment, during the additive-liquid permeation step (STEP 20), the additive liquid 10 is caused to permeate into the piece of fish meat 20 in an amount of 15 weight % with respect to a weight of the piece of fish meat 20. In more detail, the pH adjuster 12 is caused to permeate into the piece of fish meat 20 in an amount of 0.40 to 0.50 weight %, the water-soluble food material 13 is caused to permeate in an amount of 2.00 to 2.50 weight %, and the salt 15 is caused to permeate in an amount of 0.5 to 0.7 weight %, with respect to the weight of the piece of fish meat 20. Especially, the pH adjuster 12 is caused to permeate into the piece of fish meat 20 in an amount of 0.45 weight %, the water-soluble food material 13 is caused to permeate in an amount of 2.25 weight %, and the salt 15 is caused to permeate in an amount of 0.6 weight %.

According to the permeation of the additive liquid 10, with respect to the thawed piece of fish meat 20, it may be remarkably prevented that freeze denaturation occur during a subsequent re-freezing process for the piece of fish meat 20. In addition, it has been confirmed that a taste of the finally thawed and processed piece of fish meat is delicious.

Through various experiments, it has been found that the pH adjuster 12 in the additive liquid 10 is preferably caused to permeate into the piece of fish meat 20 in an amount of 0.5 weight % or below, the water-soluble food material 13 is preferably caused to permeate in an amount of 0.3 to 7.0 weight %, and the salt 15 is preferably caused to permeate in an amount of 0.15 to 2.0 weight %, with respect to the weight of the piece of fish meat 20.

In addition, in the above embodiment, the piece of fish meat 20 may be a piece of fresh fish meat before frozen. For example, the piece of fish meat 20 may be a piece of fresh codfish.

In the case wherein the piece of fresh codfish is used as the piece of fish meat 20, during the additive-liquid permeation step (STEP 20), the additive liquid 10 is caused to permeate into the fresh piece of fish meat 20 in an amount of 5 weight % with respect to the weight of the piece of fish meat 20. In more detail, the pH adjuster 12 is caused to permeate into the piece of fish meat 20 in an amount of 0.13 to 0.17 weight %, the water-soluble food material 13 is caused to permeate in an amount of 0.67 to 0.83 weight %, and the salt 15 is caused to permeate in an amount of 0.18 to 0.22 weight %, with respect to the weight of the piece of fish meat 20. Especially, the pH adjuster 12 is caused to permeate into the piece of fishmeat 20 in an amount of 0.15 weight %, the water-soluble food material 13 is caused to permeate in an amount of 0.75 weight %, and the salt 15 is caused to permeate in an amount of 0.2 weight %.

In the case too, the pH adjuster 12 in the additive liquid 10 is preferably caused to permeate into the piece of fish meat 20 in an amount of 0.5 weight % or below, the water-soluble food material 13 is preferably caused to permeate in an amount of 0.3 to 7.0 weight %, and the salt 15 is preferably caused to permeate in an amount of 0.15 to 2.0 weight %, with respect to the weight of the fish meat or the piece of fish meat.

According to the permeation of the additive liquid 10, with respect to the piece of fresh codfish, it may be remarkably prevented that freeze denaturation occur during a subsequent freezing process for the piece of fresh codfish. In addition, it has been confirmed that a taste of the finally thawed and processed piece of codfish is delicious.

The above embodiment can be applied to an entire fish body, instead of the piece of fish meat (fillet).

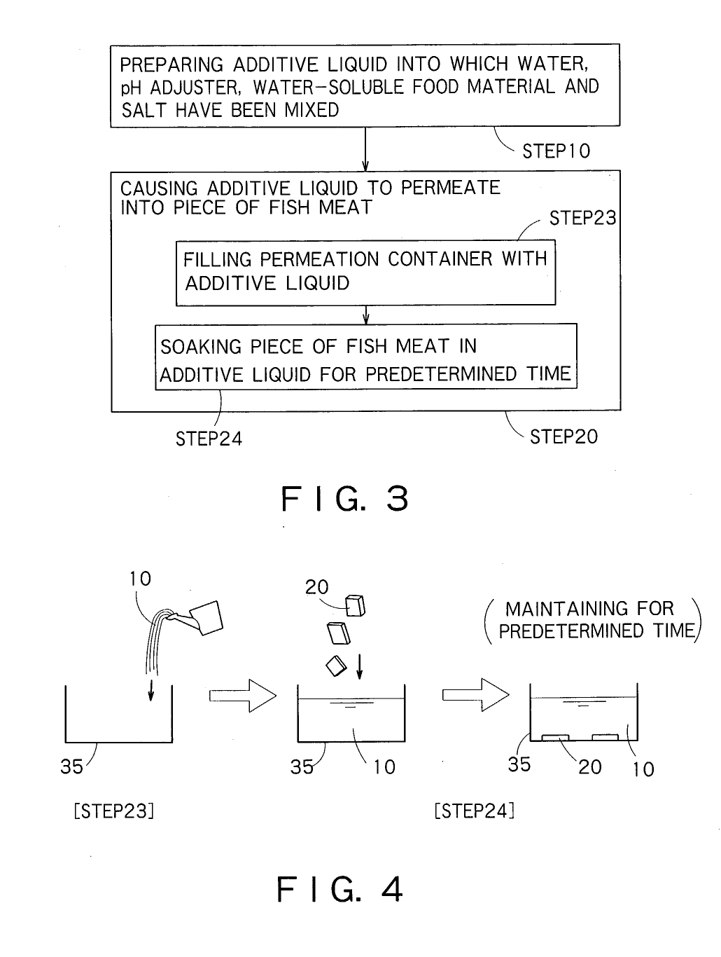

Next, with reference to FIGS. 3 and 4, a second embodiment of a method of preventing a freeze denaturation of a piece of fish meat according to the invention is explained. FIG. 3 is a flowchart of the second embodiment of the method of preventing the freeze denaturation of the piece of fish meat. FIG. 4 is a schematic view of the additive-liquid permeation step shown in FIG. 3.

As shown in FIGS. 3 and 4, the additive-liquid permeation step (STEP 20) of the second embodiment includes a step (STEP 23) of filling a permeation container 35 with the additive liquid 10, and a step (STEP 24) of soaking the piece of fish meat 20 in the additive liquid 10 in the permeation container 35 for a predetermined time. The predetermined time in the STEP 24 may be a time until an osmotic pressure between the piece of fish meat 20 and the additive liquid 10 becomes balanced or a time added a predetermined additive time to said time.

The other features of the second embodiment are substantially the same as those of the first embodiment of the method of preventing the freeze denaturation of the piece of fish meat shown in FIGS. 1 and 2. In the second embodiment, the same numeral references correspond to the same elements as the first embodiment shown in FIGS. 1 and 2. The explanation of the same elements is not repeated.

According to the additive-liquid permeation step (STEP 20) of the second embodiment, similarly to the first embodiment, with respect to both a thawed piece of fish meat and a fresh piece of fish meat, it may be remarkably prevented that freeze denaturation occur during a subsequent freezing process for the piece of fish meat. In addition, it has been confirmed that a taste of the finally thawed and processed piece of fish meat is delicious.

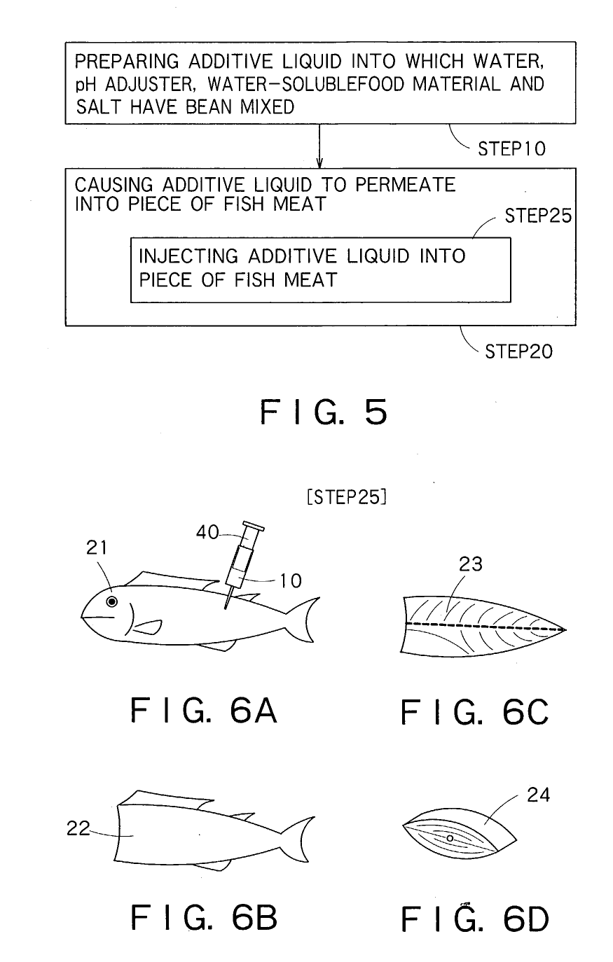

Next, with reference to FIGS. 5 and 6, a third embodiment of a method of preventing a freeze denaturation of a piece of fish meat according to the invention is explained. FIG. 5 is a flowchart of the third embodiment of the method of preventing the freeze denaturation of the piece of fish meat. FIG. 6 is a schematic view of the additive-liquid permeation step shown in FIG. 5.

As shown in FIGS. 5 and 6, the additive-liquid permeation step (STEP 20) of the third embodiment includes a step (STEP 25) of injecting the additive liquid 10 into a non-processed fish body 21, a fish body 22 whose head and/or viscera are removed, a fillet 23 or a cut piece of fish meat 24, by means of an injector 40 or the like.

The other features of the third embodiment are substantially the same as those of the first embodiment of the method of preventing the freeze denaturation of the piece of fish meat shown in FIGS. 1 and 2. In the third embodiment, the same numeral references correspond to the same elements as the first embodiment shown in FIGS. 1 and 2. The explanation of the same elements is not repeated.

According to the additive-liquid permeation step (STEP 20) of the third embodiment, similarly to the first embodiment, with respect to both a thawed piece of fish meat and a fresh piece of fish meat, it may be remarkably prevented that freeze denaturation occur during a subsequent freezing process for the piece of fish meat. In addition, it has been confirmed that a taste of the finally thawed and processed piece of fish meat is delicious.

In the above embodiments, the piece of fish meat 20 may have a regular shape, that is, may be provided as what is called a fish block. Such a piece of fish meat 20 having a regular shape such as a fish block may be frozen after the additive liquid 10 has been pressurized and caused to permeate into the piece of fish meat 20. The frozen piece of fish meat 20 may be dealt in a market. Even if a cutting process or the like is conducted to the frozen piece of fish meat, taste deterioration may be prevented because freeze denaturation is prevented during a subsequent continuous freezing process.

The piece of fish meat 20 whose freeze denaturation is prevented by any of the above embodiments may be broadly used as a uncooked fish, an ingredient for a deep-fried fish, a grilled fish such as a fish steak, an ingredient for a boiled or steamed dish, an ingredient for a sandwich or a hamburger, or the like.

According to the invention, by causing the additive liquid including the water, the pH adjuster, the water-soluble food material and the salt to permeate into the fish meat or the piece of fish meat, it may be effectively prevented that the freeze denaturation occur during the subsequent freezing process for the fish meat or the piece of fish meat.

What is claimed is:

1. A method of preventing a freeze denaturation of a fish meat or a piece of fish meat, said method comprising;
an additive-liquid preparation step of preparing an additive liquid into which water, a pH adjuster, a water-soluble food material and salt have been mixed, and
an additive-liquid permeation step of causing the additive liquid to permeate into the fish meat or the piece of fish meat.

2. A method according to claim 1, wherein:
the water-soluble food material include one of chemical condiment, natural-material extract and saccharide.

3. A method according to claim 1 or 2, wherein:
the fish meat or the piece of fish meat is a thawed fish meat or a thawed piece of fish meat.

4. A method according to claim 3, wherein:
the additive liquid is caused to permeate into the thawed fish meat or the thawed piece of fish meat in an amount of 10 to 20 weight % with respect to a weight of the thawed fish meat or the thawed piece of fish meat, during the additive-liquid permeation step.

5. A method according to claim 1 or 2, wherein:
the fish meat or the piece of fish meat is a fresh fish meat or a fresh piece of fish meat.

6. A method according to claim 5, wherein:
the additive liquid is caused to permeate into the fresh fish meat or the fresh piece of fish meat in an amount of 3 to 10 weight % with respect to a weight of the fresh fish meat or the fresh piece of fishmeat, during the additive-liquid permeation step.

7. A method according to any of claims 1 to 6, wherein:
the pH adjuster in the additive liquid is caused to permeate into the fish meat or the piece of fish meat in an amount of 0.5 weight % or below with respect to a weight of the fish meat or the piece of fish meat,
the water-soluble food material in the additive liquid is caused to permeate into the fish meat or the piece of fish meat in an amount of 0.3 to 7.0 weight % with respect to the weight of the fish meat or the piece of fish meat, and
the salt in the additive liquid is caused to permeate into the fish meat or the piece of fish meat in an amount of 0.15 to 2.0 weight % with respect to the weight of the fish meat or the piece of fish meat, during the additive-liquid permeation step.

8. A method according to claim 7, wherein:
the pH adjuster in the additive liquid is caused to permeate into the fish meat or the piece of fish meat in an amount of 0.40 to 0.50 weight % with respect to the weight of the fish meat or the piece of fish meat,
the water-soluble food material in the additive liquid is caused to permeate into the fish meat or the piece of fish meat in an amount of 2.00 to 2.50 weight % with respect to the weight of the fish meat or the piece of fish meat, and
the salt in the additive liquid is caused to permeate into the fish meat or the piece of fish meat in an amount of 0.5 to 0.7 weight % with respect to the weight of the fish meat or the piece of fish meat, during the additive-liquid permeation step.

9. A method according to claim 8, wherein:
the pH adjuster in the additive liquid is caused to permeate into the fish meat or the piece of fish meat in an amount of 0.45 weight % with respect to the weight of the fish meat or the piece of fish meat,
the water-soluble food material in the additive liquid is caused to permeate into the fish meat or the piece of fish meat in an amount of 2.25 weight % with respect to the weight of the fish meat or the piece of fish meat, and
the salt in the additive liquid is caused to permeate into the fish meat or the piece of fish meat in an amount of 0.6 weight % with respect to the weight of the fish meat or the piece of fish meat,
during the additive-liquid permeation step.

10. A method according to claim 7, wherein:
the pH adjuster in the additive liquid is caused to permeate into the fish meat or the piece of fish meat in an amount of 0.13 to 0.17 weight % with respect to the weight of the fish meat or the piece of fish meat,
the water-soluble food material in the additive liquid is caused to permeate into the fish meat or the piece of fish meat in an amount of 0.67 to 0.83 weight % with respect to the weight of the fish meat or the piece of fish meat, and
the salt in the additive liquid is caused to permeate into the fish meat or the piece of fish meat in an amount of 0.18 to 0.22 weight % with respect to the weight of the fish meat or the piece of fish meat,
during the additive-liquid permeation step.

11. A method according to claim 10, wherein:
the pH adjuster in the additive liquid is caused to permeate into the fish meat or the piece of fish meat in an amount of 0.15 weight % with respect to the weight of the fish meat or the piece of fish meat,
the water-soluble food material in the additive liquid is caused to permeate into the fish meat or the piece of fish meat in an amount of 0.75 weight % with respect to the weight of the fish meat or the piece of fish meat, and
the salt in the additive liquid is caused to permeate into the fish meat or the piece of fish meat in an amount of 0.2 weight % with respect to the weight of the fish meat or the piece of fish meat,
during the additive-liquid permeation step.

12. A method of preventing a freeze denaturation of a fish meat or a piece of fish meat, said method comprising;
an additive-liquid preparation step of preparing an additive liquid that has a higher density with respect to a substance dissolving in a cell sap in a fish-meat cell of the fish meat or the piece of fish meat than that in the cell sap, and
an additive-liquid permeation step of causing the additive liquid to permeate into the fish meat or the piece of fish meat.

13. An additive liquid for preventing a freeze denaturation of a fish meat or a piece of fish meat, comprising;
water of 74 to 82 weight %,
a pH adjuster of 2 to 4 weight %,
a water-soluble food material of 13 to 17 weight %, and
salt of 3 to 5 weight %.

14. An additive liquid for preventing a freeze denaturation of a fish meat or a piece of fish meat, comprising;
water of 78 weight %,
a pH adjuster of 3 weight %,
a water-soluble food material of 15 weight %, and
salt of 4 weight %.

15. A fish meat or a piece of fish meat into which an additive liquid has been caused to permeate, said additive liquid including water, a pH adjuster, a water-soluble food material, and salt.
